(19) United States
(12) Patent Application Publication
(10) Pub. No.: US 2025/0148911 A1
(43) Pub. Date: May 8, 2025

(54) CLOSED-LOOP SIMULATOR FOR MULTIAGENT BEHAVIOR WITH CONTROLLABLE DIFFUSION

(71) Applicant: NEC Laboratories America, Inc., Princeton, NJ (US)

(72) Inventors: Manmohan Chandraker, Santa Clara, CA (US); Francesco Pittaluga, Los Angeles, CA (US); Bingbing Zhuang, Santa Clara, CA (US); Wei-Jer Chang, Fremont, CA (US)

(21) Appl. No.: 18/933,054

(22) Filed: Oct. 31, 2024

Related U.S. Application Data
(60) Provisional application No. 63/595,526, filed on Nov. 2, 2023.
(60) Provisional application No. 63/599,534, filed on Nov. 15, 2023.

(51) Int. Cl. G08G 1/0967; G06N 20/00; G08G 1/01; G08G 1/16

(52) U.S. Cl. CPC G08G 1/096725; G06N 20/00; G08G 1/0112; G08G 1/0125; G08G 1/0145; G08G 1/166

(57) ABSTRACT

Methods and systems include determining actions for agents in a driving scenario using a diffusion model, based on individual controllable behavior patterns for the agents. A state of the driving scenario is updated based on the determined actions for the plurality of agents. The determination of actions and the update of the state are repeated in a closed-loop fashion to generate simulated trajectories for the plurality of agents. A planner model is trained to select actions for an operating agent based on the simulated trajectories.

### RELATED APPLICATION INFORMATION

This application claims priority to U.S. Patent Application No. 63/595,526, filed on Nov. 2, 2023, and to U.S. Patent Application No. 63/599,534, filed on Nov. 15, 2023, each incorporated herein by reference in its entirety.

### BACKGROUND

### Technical Field

The present invention relates to machine learning systems and, more particularly, to the generation of simulated training data.

### Description of the Related Art

Training decision making systems for self-driving vehicles relies on having a training dataset that includes a wide variety of scenarios. These scenarios provide information to a machine learning model to help it make safe decisions in challenging circumstances. However, the most dangerous scenarios tend to be rare in reality, and so it is difficult to obtain real-world training data for such scenarios. This can impair the efficacy of the decision making system when the consequences of an error are at their most severe.

### SUMMARY

A method includes determining actions for agents in a driving scenario using a diffusion model, based on individual controllable behavior patterns for the agents. A state of the driving scenario is updated based on the determined actions for the plurality of agents. The determination of actions and the update of the state are repeated in a closed-loop fashion to generate simulated trajectories for the plurality of agents. A planner model is trained to select actions for an operating agent based on the simulated trajectories.

A system includes a hardware processor and a memory that stores a computer program. When executed by the hardware processor, the computer program causes the hardware processor to determine actions for a plurality of agents in a driving scenario using a diffusion model, based on individual controllable behavior patterns for the plurality of agents, to update a state of the driving scenario based on the determined actions for the plurality of agents, to repeat the determination of actions and the update of the state in a closed-loop fashion to generate simulated trajectories for the plurality of agents, and to train a planner model to select actions for an operating agent based on the simulated trajectories.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a top-down view of a driving scenario with a controlled vehicle and other agents, in accordance with an embodiment of the present invention;

FIG. 2 is a block diagram illustrating the generation of a training scenario using a diffusion model guided by a language model, in accordance with an embodiment of the present invention;

FIG. 3 is a block/flow diagram of a method for training and using a planner model for a self-driving vehicle using simulated driving scenarios, in accordance with an embodiment of the present invention;

FIG. 4 is a diagram of an exemplary driving scene as seen from an autonomous vehicle, in accordance with an embodiment of the present invention;

FIG. 5 is a diagram of control systems within an autonomous vehicle, in accordance with an embodiment of the present invention;

FIG. 6 is a block diagram of a computing device that can train and use a planner model using simulated driving scenarios, in accordance with an embodiment of the present invention;

FIG. 7 is a diagram of an exemplary neural network architecture that can be used to implement part of a diffusion model, in accordance with an embodiment of the present invention; and

FIG. 8 is a diagram of an exemplary deep neural network architecture that can be used to implement part of a diffusion model, in accordance with an embodiment of the present invention.

### DETAILED DESCRIPTION OF PREFERRED EMBODIMENTS

Training a decision making system for a self-driving vehicle can be improved by providing a wide variety of training data, including data for rare events that may nonetheless have high consequences for errors. A simulator may be used to generate realistic adversarial scenarios that occur rarely in the real world. Such scenarios may include multi-agent systems, where the behavior of each agent may impact those of all the others. The scenarios may further be influenced by traffic rules, where the rules do not strictly constrain the agents, but nonetheless influence their behavior.

To this end, a diffusion model may be used to generate diverse behaviors with a given initialization, where the model controls the behaviors of all agents in a given scene. Guidance objectives may be used to control the diffusion model along interpretable dimensions, such as collision avoidance and route following. The diffusion model may be trained for closed-loop simulation, where behaviors of the agents impact one another, to produce long-term simulations that are consistent with traffic rules.

In addition to normal driving behaviors, adversarial training can also be used to teach the model to simulate uncommon, but realistic, behaviors where the decision making system on a self-driving vehicle might otherwise produce incorrect outputs. The generation of adversarial behaviors for the agents may use a framework that provides an understanding of failure modes of decision making system. The simulator can then be controlled, for example through language-based inputs, using a large language model (LLM) to encode an understanding of traffic rules in the trained diffusion model.

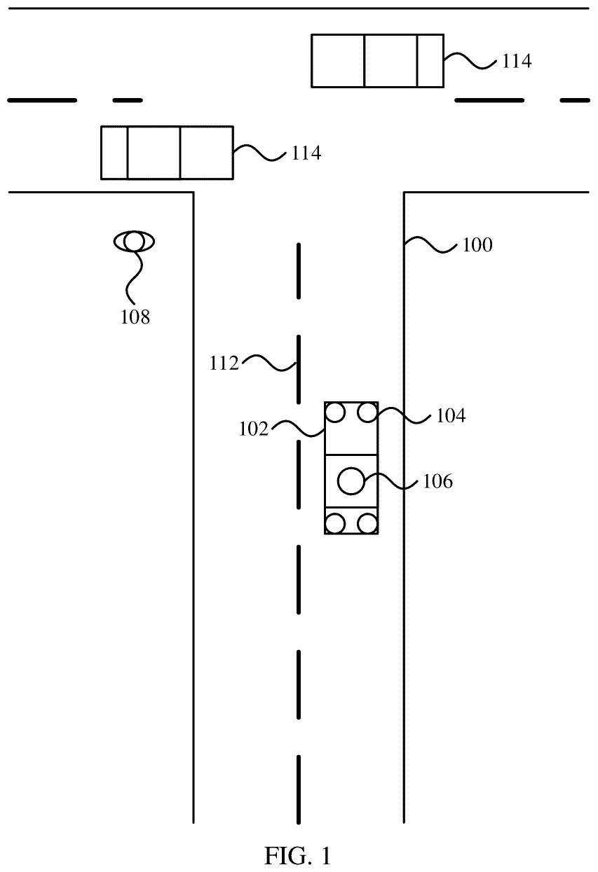

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree Light Direction and Ranging (LiDAR) sensor 106, positioned to gather geometric information about the road 100 all around the vehicle 102.

The vehicle 102 records information from its sensors. The information may be used to identify other vehicles 114, structural features such as lamp posts and traffic control features, as well as animals and pedestrians 108. The information may further include road markings 112 and signage that indicates how the vehicle 102 is to operate, such as speed limit signs.

During a realistic scenario, the other vehicles 114 interact with the road 100, one another, pedestrians 108, and any other elements of the scene to make their own independent decisions about how to proceed. Their operation is generally governed by laws and rules governing the operation of motor vehicles, but vehicles 114 will occasionally break these rules by, for example, speeding or leaving their designated lanes. Additionally, while vehicles 114 will typically behave in a predictable, careful manner, they may occasionally operate in unexpected ways due to accident, inattention, or aggression by their operators.

As the vehicle 102 attempts to make decisions about how to proceed, based on the information it gathers from its sensors, it is limited by the types of scenarios that it was exposed to during training. If one of the other vehicles 114 begins to operate in a manner that was not shown in the training dataset, then the vehicle 102 may make an unsafe decision about its next actions, resulting in damage or injury.

To better prepare the vehicle 102 for such scenarios, real-world driving logs may be combined with simulated scenarios to ensure that the decision making model has access to information about uncommon, dangerous scenarios. While such simulated scenarios may be designed manually, such targeted testing is limited in its scalability and lacks the comprehensiveness needed to thoroughly evaluate the operation of a self-driving system.

Simulated scenarios may therefore be generated in a closed-loop fashion, where the other vehicles 114 react to the behavior of the operating vehicle 102 and to one another in an ongoing simulation. The behavior of these agents is realistic, controllable, and can be simulated over a long time horizon.

Using a diffusion model to generate the simulations, test-time guidance directs the denoising phase of the diffusion process, using the gradients from differentiable objectives. A balanced integration of adversarial objectives and regularization is introduced to the guidance phase, which provides control over the conditions of the generated scenarios to ensure their realism and relevance to safety-critical testing.

A simulated traffic scenario may include N agents. One is the self-driving vehicle 102 that is controlled by a planner π, while the remaining N-1 vehicles 114 are reactive agents modeled by a function g. A closed-loop simulation determines realistic, controllable behavior for the reactive agents. This provides for the identification of possible failures in the planner π, such as collision events.

In the traffic scenario, at any given timestep t, the state of the N vehicles is represented by sₜ=[sₜ¹, . . . , sₜ^{N}], where sₜⁱ=(xₜⁱ,yₜⁱ,vₜⁱ,θₜⁱ), characterized by two-dimensional coordinates xₜⁱ and yₜⁱ, speed vₜⁱ, and yaw θₜⁱ of a vehicle i. The corresponding action for each vehicle is aₜ=[aₜ¹, . . . , aₜ^{N}], with aₜⁱ=(\dot{v}ₜⁱ, \dot{θ}ₜⁱ) representing he acceleration and yaw rate. A transition function ƒ(·) predicts the state at the next timestep t+1, so that sₜ₊₁=ƒ(sₜ, aₜ) based on a current state and action.

Each agent's decision context is c, including the agent-centric map M and the historical states of neighboring vehicles from time t-Tₕᵢₛₜ to t, defined as s_{t-T}_{ₕᵢₛₜ}_{:t}={s_{t-T}_{ₕᵢₛₜ}, . . . , sₜ}. In a closed-loop traffic simulation, each agent continuously generates and updates its trajectory based on its current decision context c. After generating a trajectory, the simulation executes the first few steps of the planned actions before updating c and re-executing its planning.

The planner π determines the operating vehicle's future trajectory over a time horizon from t to t+T. The planned state sequence is denoted by s_{t:t+T}¹=π(c), where π(c) processes the historical states and map data within c to anticipate and compute the upcoming states.

The reactive agent model g, parameterized by θ, is designed to simulate the behavior of the N-1 other vehicles 114, represented by the set {s_{t:t+T}ⁱ}ᵢ₌₂^{N}. Each vehicle's state sequence, s_{t:t+T}ⁱ, is generated by g_{θ}(c, ψᵢ), which incorporates the decision context c and a set of control parameters ψᵢ unique to each agent. These parameters enable the finetuning of individual behaviors within the simulation.

The model g may be trained on real-world driving data to ensure the trajectories that it produces are not only controllable, supporting the generation of various safety-critical scenarios, but also realistic.

An adversarial loss is reduced in complex environments and is used during inference. An objective function may be mathematically represented as:

$${min}_{{ψ}_{i}} {L}_{adv} ( π , g ( {ψ}_{i} ) )$$

where L_{adv} denotes the adversarial loss function, such as collision risk, assessing the performance of the planner π in response to the adversarial agent's behavior, determined by parameters ψᵢ. Concurrently, other agents in the simulation, regulated by g with varying parameters, emulate authentic, reactive behaviors. This configuration ensures that the adversarial agent poses challenges to the planner π, while the other agents enrich the scenario with realistic and diverse traffic conditions.

The loss function for the non-reactive agents, J(τ), includes a collision term J_{coll}, which encourages collisions between the adversarial agent and the ego agent, two control terms Jᵥ and J_{ttc}, which control the relative speed and time-to-collision between the ego and adversarial agent respectively, a regularization term J_{Gauss}, which discourages collisions between the reactive agents, and a route guidance term Jroute, which discourages the reactive agents from going outside the road:

$$J ( τ ) = ρ \underbrace{( {J}_{c o l l} + {J}_{v} + {J}_{t t c} )}_{{J}_{a d v} ( τ )} + \underbrace{{J}_{r o u t e} + {J}_{G a u s s}}_{{J}_{r e g} ( τ )}$$

where ρ denotes a scalar weight that determines whether a reactive agent behaves adversarially towards the controlled agent, i.e., whether it attempts to collide with the vehicle 102.

A closed-loop system is used. Within this system, the planner π, and the reactive agents, both adversarial and non-adversarial, continuously interact. This ongoing interaction fosters dynamic and evolving driving situations, which are essential for thoroughly assessing the planner's capability to adapt interactively in varied traffic environments. Meanwhile, trajectory diffusion models are used to generate realistic simulations.

The model's operational trajectory is represented as τ, which includes both action and state sequences: τ:=[τₐ, τₛ]. Specifically, τₐ:=[a₀, . . . , a_{T-1}] represents the sequence of actions, while τₛ:=[s₁, . . . , s_{T}] denotes the corresponding sequence of states. The model predicts the action sequence τₐ, while the state sequence τₛ can be derived starting from the initial state s₀ and dynamics model f.

In the context of trajectory generation, a diffusion model creates a trajectory by reversing a process that incrementally adds noise. Starting with an actual trajectory sampled from the data distribution τ₀, a sequence of increasingly noisy trajectories τ₁, . . . , τ_{K} is produced via a forward noising process. Each trajectory τₖ at step k is generated by adding Gaussian noise parameterized by a predefined variance schedule βₖ:

$$q ( {τ}_{1 : K} \vert {τ}_{0} ) = {\prod }_{k = 1}^{K} q ( {τ}_{k} \vert {τ}_{k - 1} )$$

$$q ( {τ}_{k} \vert {τ}_{k - 1} ) = 𝒩 ( {τ}_{k} ; \sqrt{1 - {β}_{k}} {τ}_{k - 1} , {β}_{k} I )$$

The noising process gradually obscures the data, where the final noisy version q(τ_{K}) approaches the Gaussian distribution [symbol] (τ_{K}; 0, I).

The trajectory generation process is then achieved by learning the reverse of this noising process. Given a noisy trajectory τ_{K}, the model learns to denoise it back to τ₀ through a sequence of reverse steps. Each reverse step is modeled as:

$${P}_{θ} ( {τ}_{k - 1} \vert {τ}_{k} , c ) = 𝒩 ( {τ}_{k - 1} ; {μ}_{θ} ( {τ}_{k} , k , c ) , {\sum }_{k} ) )$$

where θ are learned functions that predict the mean of the reverse step, and Σₖ is a fixed schedule. By iteratively applying the reverse process, the model learns a trajectory distribution, effectively generating a plausible future trajectory from a noisy start.

During the trajectory prediction phase, the model estimates the final clean trajectory denoted by \hat{τ}⁰. This estimated trajectory is used to compute the reverse process mean μ. The training objective is to minimize the expected difference between the true initial trajectory and the one estimated by the model, formalized by the loss function:

$$ℒ = {E}_{ϵ , k , {τ}_{0} , C} [ {‖ {τ}_{0} - {\hat{τ}}_{0} ‖}^{2} ]$$

where τ₀ and C are sampled from the training dataset, k˜ [symbol] {1,2, . . . , K} is the timestep index sampled uniformly at random, and ϵ˜ [symbol] (0, I) is Gaussian noise used to perturb τ₀ to produce the noised trajectory τₖ.

The diffusion model, once trained on realistic trajectory data, reflects the behavioral patterns present in its training distribution. To effectively simulate and analyze safety-critical scenarios, however, controlled manipulation of agent behaviors is needed. Adversarial behaviors can thereby be generated to ensure long-term scene consistency in simulations.

Guidance may therefore be introduced to the sampled trajectories at each denoising step, aligning them with predefined objectives J(τ). Guidance involves using the gradient of J to subtly perturb the predicted mean of the model at each denoising step. This adjustment results in the transformation of μ into δ_{μ}, thereby enabling the generation of trajectories that not only reflect realistic behavior but that also cater to specific simulation needs such as adversarial testing and maintaining scene coherence over extended periods.

Clean guidance in the trajectory simulation helps to manage the challenges of noisy data, which can lead to errors and instability. The model's clean prediction \hat{τ}₀ can be refined rather than trying to correct the noisy data directly, producing more stable and accurate simulation outcomes.

Given that the denoising steps involve handling noisy trajectory data, which can lead to numerical instability, the guidance is operating on the model's clean prediction to. The clean prediction may be adjusted as:

$${\hat{τ}}_{0} = {\hat{τ}}_{0} - α {\sum }_{k} {∇}_{{τ}_{k}} J ( {\hat{τ}}_{0} )$$

This strategy enhances the robustness of the guidance process, ensuring a smoother and more stable trajectory output that is free from numerical issues associated with noisy data.

Without proper guidance, diffusion models may cause an operating vehicle 102 to deviate from the drivable area or engage in a collision. To mitigate these issues, and to promote long-duration realistic simulation fidelity, route-based and Gaussian-based guidance functions may be employed. These functions effectively constraint he vehicle's trajectory, ensuring adherence to traffic routes and safe distances from other agents in the simulation.

Given an agent's trajectory τ and the corresponding route g, a tangential distance of each point it on the trajectory may be computed to the route at each time step. Deviations from the route that exceed a predefined margin d may be penalized. This process is captured by the following route guidance cost function:

$${J}_{route} ( τ , g ) = {\sum }_{t = 1}^{T} max ( 0 , \vert {d}_{t} ( {τ}_{t} , g ) - {d}_{m} \vert )$$

where dₘ is an acceptable deviation margin from the route. Here dₜ(τₜ,g) denotes the tangential distance from the point τₜ on the trajectory to the nearest point on the route g at time step t.

Given the trajectories of the agents in the scene, a Gaussian distance may be calculated for each pair of agents (i,j) at each time step t from 1 to T. The Gaussian distance between the agents takes into account both tangential (dₜ) and normal (dₙ) components of the projected distances. The aggregated Gaussian distance may be computed as:

$${J}_{G a u s s i a n} = {{\sum }_{t = 1}}^{T} {{\sum }_{i , j}}^{N} {e}^{- \frac{1}{2 {σ}^{2}} ( {( {d}_{t}^{i j} ( t ) )}^{2} + {( {d}_{n}^{i j} ( t ) )}^{2} )}$$

where dₜ^{ij}(t) and d_{N}^{ij}(t) are the tangential and normal distances from agent j's trajectory point at time t to agent i's heading axis, respectively, and σ is the standard deviation for these distances. By accounting for both tangential and normal components, the Gaussian collision distance significantly enhances collision rate predictions. These guidance objectives use the gradient of J to perturb the predicted mean of the model at each denoising step.

The collision guidance is based on different agent interactions. The denoising process of all agents within a scene may be extended into the batch dimension. During inference, to generate M samples, it may be assumed that each sample corresponds to the same m^{th} example of the scene. For the operating vehicle 102, the future state predictions are derived from the identical diffusion model used for other agents. The collision distance for the operating vehicle 102 is then determined considering these predictions and their interactions with other agents within the scene.

Thus a scenario may include an operating agent, a reactive agent, and an adversary agent. All the agents run simultaneously in the scene and interact with one another in a closed-loop fashion. The adversarial component is introduced in the denoising process to improve the realism of the agent interactions. A loss function for guiding reactive agents is:

$$J ( τ ) = {J}_{r e g} + {J}_{adv} + {J}_{att}$$

where J_{reg} guides agents along their paths while avoiding collisions, promoting realistic behavior, J_{adv} introduces adversarial elements by favoring situations where collisions could occur with the operating agent, but only when the adversary agent and the main agent are within a certain distance, and Jₐₜₜ adjusts agent behavior based on attributes such as speed and driving style. The J_{adv} applies solely to the adversary agent to balance between challenge and traffic rules compliance, ensuring that scenarios remain realistic.

Scenarios are started based on actual traffic logs, leveraging a learned behavior model. The J_{adv} term provides behavior modification and control over safety-critical scenarios. Agent behavior is nudged toward aggressiveness without globally altering the scenario dynamics. All agents interact in a closed-loop simulation, providing a more comprehensive assessment than if only the operating agent responded to other agents.

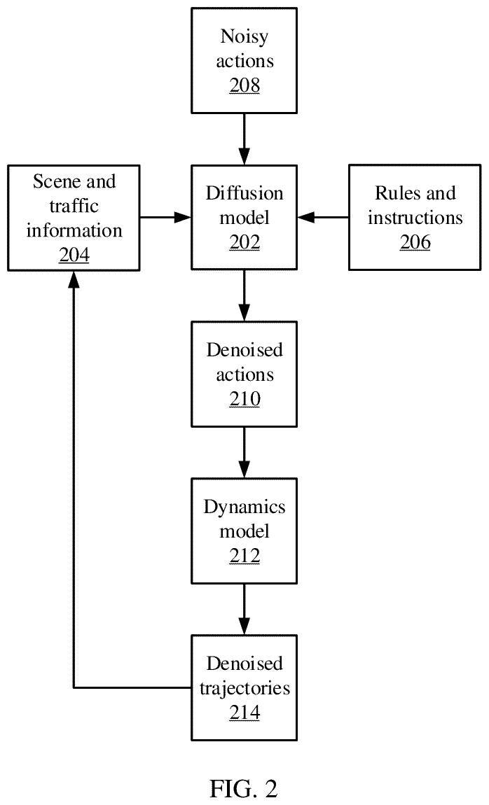

Referring now to FIG. 2, a diagram of a simulation framework is shown. A diffusion model is used to simulate a scenario, taking noisy actions 208 as an input and producing denoised actions 210, which are converted to denoised trajectories 214 using a dynamics model 212. The model takes scene and traffic information 204 as input, optionally with rules and instructions 206 from an LLM. The denoised trajectories 214 are used to update the state of the scene and traffic information 204 for a next time step and the process is repeated to simulate the actions of the various agents in the scene in a closed-loop fashion. The diffusion model 202 may be trained to be controllable with several guidance objectives.

The gradient signal for the diffusion model 202 may be perturbed by an objective that quantifies deviation from the planned route in terms of lane margins. Another type of guidance is Gaussian collision, where the gradient signal for the diffusion model 202 is perturbed by an objective that quantifies the cost of collisions between simulated agents using Gaussian margins around the agents.

The diffusion model 202 thereby generates realistic behaviors for agents in the scene that cause a planner of an operating vehicle to produce collisions, off-road operation, or sub-optimal goal reaching behaviors. Adversarial trajectories can be generated even though the interactions are with the operating vehicle and not a simulated trajectory for the operating vehicle. The diffusion model 202 may be controlled with meaningful variables, such as speed or acceleration, to provide interpretable adversarial scenarios.

The diffusion model 202 may be implemented using a U-Net diffusion model. The scene and traffic information 204 may be encoded using a Resnet encoder. The rules and instructions 206 may be rendered in a form suitable for input to the diffusion model 202 using an LLM. The dynamics model 212 may be implemented using unicycle dynamics.

The instructions to the LLM may indicate initial scene conditions and may request a description of how the scene will progress over a specified number of seconds. The diffusion model 202 uses the output of the LLM by conditioning its diffusion process on the LLM's output.

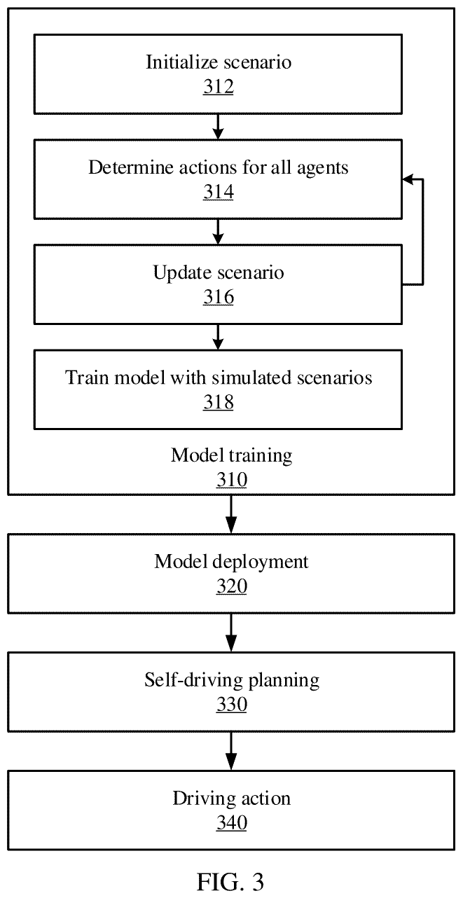

Referring now to FIG. 3, a method for training and using a self-driving model is shown. Block 310 trains the self-driving model using simulated scenarios. This may include block 312, initializes a scenario by placing agents within a realistic road scene. This initialization may be based on real driving logs and may place vehicles with corresponding initial directions and speeds.

Block 314 determines an action for all of the agents within the scene, including the operating agent and the reactive agent. The agents have individually controllable behavior parameters, for example governing the aggressiveness of their driving actions. Based on the determined actions, block 316 updates the scenario, for example by updating the locations, directions, and speeds of the different agents in accordance with their respective actions. This process repeats in a closed-loop fashion, determining new actions 314 and updating the scenario 316 until some stopping condition has been reached. Exemplary stopping conditions include a predetermined number of iterations or the operating agent moving a threshold distance away from the closest reactive agent.

Once one or more scenarios have been generated, they may be used to train a planner model in block 318. This may include training a policy function using imitation learning, where the scenarios show realistic strategies for operating safely and successfully in a variety of adversarial scenarios.

Block 320 then deploys the trained model to, e.g., a self-driving vehicle by copying the model parameters to the vehicle. Block 330 uses the trained model to perform self-driving planning by taking in sensor information from a road scene and generating a recommended action based on the output of the model. Block 340 then performs a driving action in accordance with the recommended action of block 330. The driving action may include, for example, a steering, braking, or acceleration action to change a direction and/or speed of the self-driving vehicle.

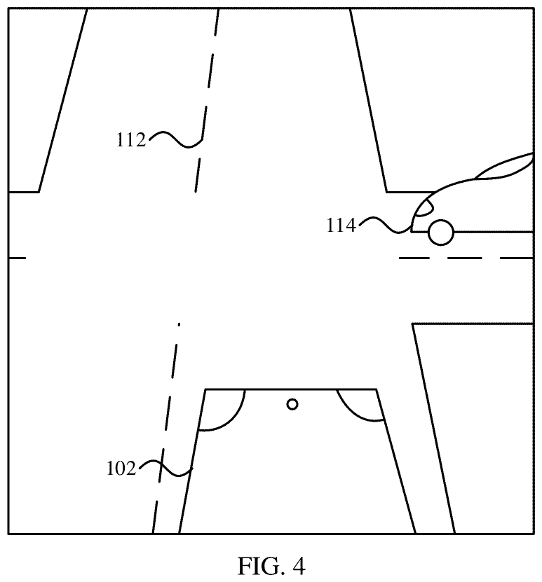

Referring now to FIG. 4, an example road scene is shown. The scene may be captured by a camera that is mounted on a vehicle 102, and may show the surroundings of the vehicle 102 from a particular perspective. It should be understood that multiple such images may be used to show various perspectives, to ensure awareness of the vehicle's entire surroundings. In some cases, a panoramic or 360° camera may be used.

The planning model may process an image of the scene and identify different objects that are shown in the scene, generating an action for how the vehicle 102 should act to reach its destination safely. The model may detect environmental features, such as the road boundary and lane markings 112, as well as moving objects, such as other vehicles 114. Using this information, a navigation or self-driving system in the vehicle 102 can safely navigate through the scene.

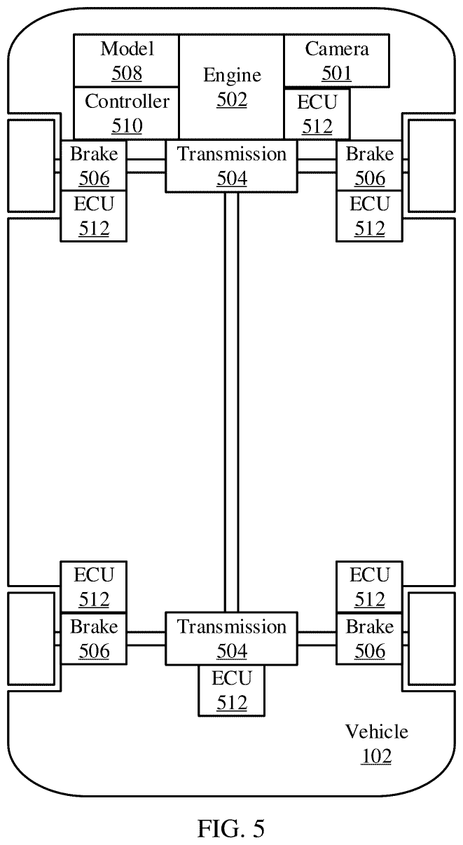

Referring now to FIG. 5, additional detail on a vehicle 102 is shown. A number of different sub-systems of the vehicle 102 are shown, including an engine 502, a transmission 504, and brakes 506. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 512, which perform measurements of the state of the respective sub-system. For example, ECUs 512 relating to the brakes 506 may control an amount of pressure that is applied by the brakes 506. An ECU 512 associated with the wheels may further control the direction of the wheels. The information that is gathered by the ECUs 512 is supplied to the controller 510. A camera 501 or other sensor (e.g., LiDAR or RADAR) can be used to collect information about the surrounding road scene, and such information may also be supplied to the controller 510.

Communications between ECUs 512 and the sub-systems of the vehicle 102 may be conveyed by any appropriate wired or wireless communications medium and protocol. For example, a car area network (CAN) may be used for communication. The time series information may be communicated from the ECUs 512 to the controller 510, and instructions from the controller 510 may be communicated to the respective sub-systems of the vehicle 102.

The controller 510 uses the output of the object detection model 508, based on information collected from cameras 501, to identify objects and hazards within the scene. The model 508 may, for example, determine a driving action to perform responsive to the present state of the scene. Because the model 508 has been trained on diverse simulated inputs, it will determine a safe and efficient path to its destination.

The controller 510 may communicate internally, to the sub-systems of the vehicle 102 and the ECUs 512. Based on detected road fault information, the controller 510 may communicate instructions to the ECUs 512 to avoid a hazardous road condition. For example, the controller 510 may automatically trigger the brakes 506 to slow down the vehicle 102 and may furthermore provide steering information to the wheels to cause the vehicle 102 to move around a hazard.

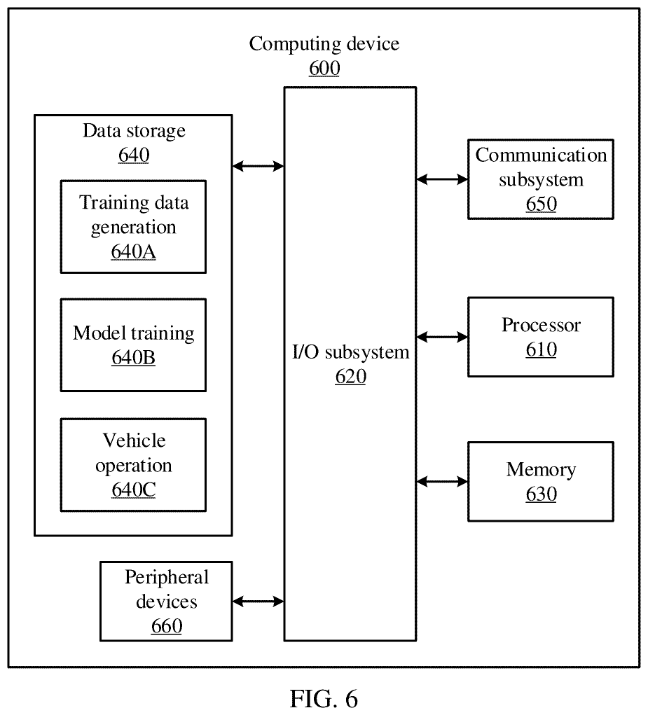

Referring now to FIG. 6, an exemplary computing device 600 is shown, in accordance with an embodiment of the present invention. The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for generating training data, 640B for training planner model, and/or 640C for performing vehicle operation actions using the trained planner model. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

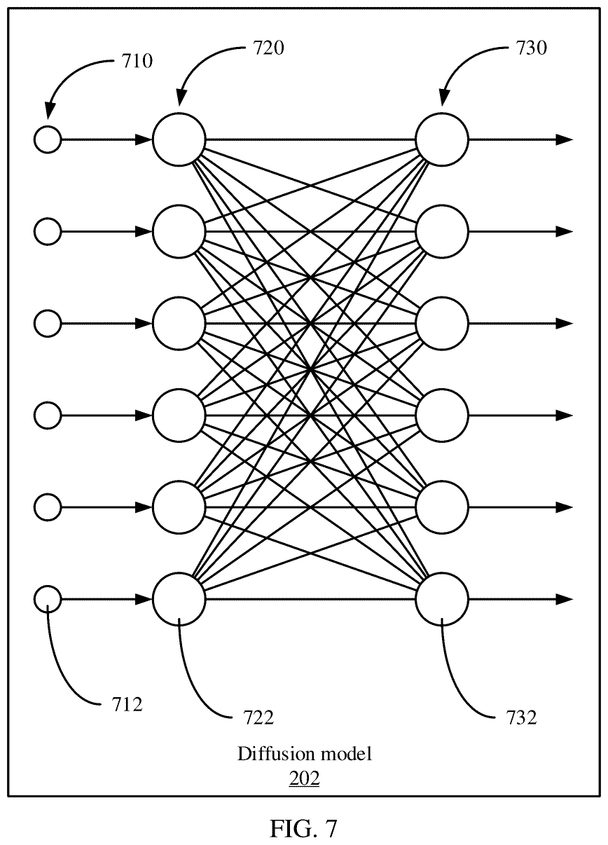

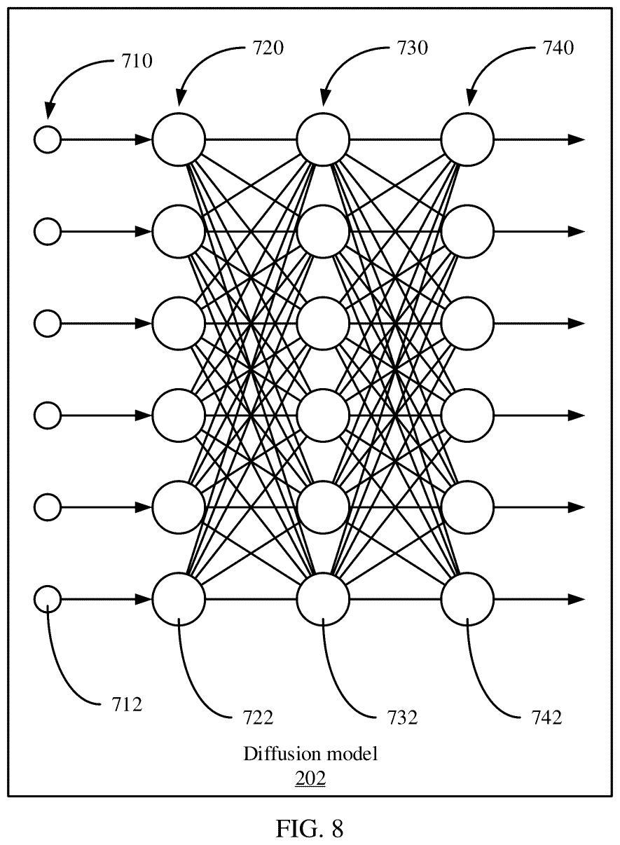

Referring now to FIGS. 7 and 8, exemplary neural network architectures are shown, which may be used to implement parts of the present models, such as the diffusion model 202. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x,y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
determining actions for a plurality of agents in a driving scenario using a diffusion model, based on individual controllable behavior patterns for the plurality of agents;
updating a state of the driving scenario based on the determined actions for the plurality of agents;
repeating the determination of actions and the update of the state in a closed-loop fashion to generate simulated trajectories for the plurality of agents; and
training a planner model to select actions for an operating agent based on the simulated trajectories.

2. The method of claim 1, wherein the diffusion model denoises actions, further comprising applying a dynamics model to generate trajectories from the denoised actions.

3. The method of claim 2, wherein the diffusion model uses a gradient of a guidance function to denoise actions, including a route-based objective function.

4. The method of claim 2, wherein the diffusion model uses a gradient of a guidance function to denoise actions, including a Gaussian-based objective function.

5. The method of claim 1, wherein the diffusion model controls the behavior patterns based on instructions generated by a large language model.

6. The method of claim 1, wherein at least one of the plurality of agents is set to engage in adversarial behavior.

7. The method of claim 1, wherein updating the scenario includes moving the agents within the driving scenario in accordance with trajectories that are affected by the determined actions.

8. The method of claim 1, further comprising generating a driving action using the planner model responsive to a new scenario and performing the driving action in an autonomous vehicle.

9. The method of claim 8, wherein the new scenario is based on camera information collected by the autonomous vehicle.

10. The method of claim 8, wherein the driving action is selected from the group consisting of a steering action, a braking action, and an acceleration action.

11. A system, comprising:
a hardware processor; and
a memory that stores a computer program which, when executed by the hardware processor, causes the hardware processor to:
determine actions for a plurality of agents in a driving scenario using a diffusion model, based on individual controllable behavior patterns for the plurality of agents;
update a state of the driving scenario based on the determined actions for the plurality of agents;
repeat the determination of actions and the update of the state in a closed-loop fashion to generate simulated trajectories for the plurality of agents; and
train a planner model to select actions for an operating agent based on the simulated trajectories.

12. The system of claim 11, wherein the diffusion model denoises actions, further comprising applying a dynamics model to generate trajectories from the denoised actions.

13. The system of claim 12, wherein the diffusion model uses a gradient of a guidance function to denoise actions, including a route-based objective function.

14. The system of claim 12, wherein the diffusion model uses a gradient of a guidance function to denoise actions, including a Gaussian-based objective function.

15. The system of claim 11, wherein the diffusion model controls the behavior patterns based on instructions generated by a large language model.

16. The system of claim 11, wherein at least one of the plurality of agents is set to engage in adversarial behavior.

17. The system of claim 11, wherein the update of the scenario includes moving the agents within the driving scenario in accordance with trajectories that are affected by the determined actions.

18. The system of claim 11, wherein the computer program further causes the hardware processor to generate a driving action using the planner model responsive to a new scenario and performing the driving action in an autonomous vehicle.

19. The system of claim 18, wherein the new scenario is based on camera information collected by the autonomous vehicle.

20. The system of claim 18, wherein the driving action is selected from the group consisting of a steering action, a braking action, and an acceleration action.
